(19) United States
(12) Patent Application Publication
(10) Pub. No.: US 2016/0208895 A1
(43) Pub. Date: Jul. 21, 2016

(54) STRUCTURE FOR SECURING TRANSMISSION STATOR SHAFT

(71) Applicant: HONDA MOTOR CO., LTD., Tokyo (JP)

(72) Inventor: Satoshi Uchino, Wako-shi (JP)

(73) Assignee: HONDA MOTOR CO., LTD., Tokyo (JP)

(21) Appl. No.: 14/914,055

(22) PCT Filed: Aug. 6, 2014
(86) PCT No.: PCT/JP2014/070701

§ 371 Date: Feb. 24, 2016

(30) Foreign Application Priority Data
Sep. 4, 2013 (JP) 2013-183216

(51) Int. Cl. F16H 37/02; F16H 57/021

(52) U.S. Cl. CPC F16H 37/021; F16H 57/021

(57) ABSTRACT

A structure for securing a transmission stator shaft is provided in which a stator shaft flange that is integral with a stator shaft supported on an outer periphery of an input shaft via a bearing is fitted into a recess portion formed in a side face of a casing and positioned in a radial direction, and is positioned in an axial direction by a lid member that is secured to the side face by a bolt. Thus, even if the meshing reaction force in the radial direction received by a gear supported on the input shaft is transmitted to the stator shaft flange via the bearing and the stator shaft, the load is supported by the recess portion of the casing so as not to be transmitted to the bolt, thereby preventing loose of the bolt and suppressing rattling of the stator shaft flange.

### TECHNICAL FIELD

The present invention relates to a structure for securing a transmission stator shaft, in which a torque converter for transmitting a driving force of a drive source to an input shaft includes the stator shaft that is fitted around an outer periphery of the input shaft and has a stator connected to one end thereof, and a stator shaft flange that is provided at the other end of the stator shaft and is secured to a casing, a gear for transmitting the driving force of the drive source to an output shaft being supported on the input shaft.

### BACKGROUND ART

An arrangement in which a stator of a torque converter transmitting the driving force of an engine to an input shaft is supported via a one-way clutch on one end side of a stator shaft fitted around the outer periphery of the input shaft, and a stator shaft flange provided integrally with the other end side of the stator shaft is secured to a side face of a casing by means of a bolt is known from Patent Document 1 below.

### RELATED ART DOCUMENTS

### Patent Documents

Patent Document 1: International Patent Application Laid-open No. WO2011/108316

### SUMMARY OF THE INVENTION

### Problems to be Solved by the Invention

Since the stator shaft is supported on the outer periphery of the input shaft via a bearing, when a load in a radial direction acts on the input shaft due to meshing reaction force received by a gear provided on the input shaft, the load is transmitted from the bearing to the bolt via the stator shaft and the stator shaft flange, and there is a possibility that the bolt will become loose and rattling will occur between the stator shaft flange and a seating face of the casing. In order to prevent this from happening, the number of bolts may be increased or a bolt having a large diameter may be used, but by so doing there is the problem that the number of components or the weight increases.

The present invention has been accomplished in light of the above circumstances, and it is object thereof to position a stator shaft flange of a torque converter in the radial direction with respect to a casing using a simple structure.

### Means for Solving the Problems

In Order to attain the above object, according to a first aspect of the present invention, there is provided a structure for securing a transmission stator shaft, in which a torque converter for transmitting a driving force of a drive source to an input shaft comprises the stator shaft that is fitted around an outer periphery of the input shaft and has a stator connected to one end thereof, and a stator shaft flange that is provided at the other end of the stator shaft and is secured to a casing, a gear for transmitting the driving force of the drive source to an output shaft being supported on the input shaft, wherein the input shaft is supported on the stator shaft by a first bearing on one end side in an axial direction with respect to the gear and is also supported on the casing by a second bearing on the other end side in the axial direction with respect to the gear, and the stator shaft flange is fitted into a recess portion formed in a side face of the casing and positioned in a radial direction.

Further, according to a second aspect of the present invention, in addition to the first aspect, a lid member is secured to the side face of the casing, and the stator shaft flange is positioned in the axial direction by being sandwiched between the recess portion and the lid member.

Furthermore, according to a third aspect of the present invention, in addition to the first or second aspect, a drive sprocket relatively rotatably supported on an outer periphery of the stator shaft and driven by the driving force of the drive source and a driven sprocket provided on a pump shaft of an oil pump are connected by an endless chain.

Moreover, according to a fourth aspect of the present invention, in addition to any one of the first to third aspects, the transmission comprises a belt type continuously variable transmission mechanism having an endless belt wound around a first pulley and a second pulley, a first speed reduction path that can reduce rotation of the input shaft in speed and transmit the rotation to the first pulley, and a second speed reduction path that can reduce rotation of the second pulley in speed and transmit the rotation to the output shaft, the gear being an output gear of the second speed reduction path.

An engine E of an embodiment corresponds to the drive source of the present invention, a transmission case 11 of the embodiment corresponds to the casing of the present invention, first output shaft 13A of the embodiment corresponds to the output shaft of the present invention, first and second reduction gears 36 and 37 of the embodiment correspond to the first speed reduction path of the present invention, first and second induction gears 38 and 39 of the embodiment correspond to the second speed reduction path of the present invention, the first induction gear 38 in particular corresponds to the gear of the present invention, a needle bearing 43 of the embodiment corresponds to the first bearing of the present invention, and a ball bearing 59 of the embodiment corresponds to the second bearing of the present invention.

### Effects of the Invention

In accordance with the first aspect of the present invention, the torque converter for transmitting the driving force of a drive source to the input shaft includes the stator shaft that is fitted around the outer periphery of the input shaft and has the stator connected to one end, and the stator shaft flange that is provided at the other end of the stator shaft and is secured to the casing, and the gear for transmitting the driving force of the drive source to the output shaft is being supported on the input shaft. Since the input shaft is supported on the stator shaft by means of the first bearing on one end side in the axial direction with respect to the gear and is also supported on the casing by means of the second bearing on the other end side in the axial direction with respect to the gear, the load in the radial direction acts on the first and second bearings due to the meshing reaction force received by the gear, a part via which the stator shaft flange integral with the stator shaft, which receives the load in the radial direction from the first bearing, is secured to the casing becomes loose, and it becomes easy for rattling to occur. However, the stator shaft flange is fitted into the recess portion formed in the side face of the casing and is positioned in the radial direction, and the load in the radial direction is thereby directly supported by the casing, thus suppressing rattling of the stator shaft flange.

Furthermore, in accordance with the second aspect of the present invention, since the lid member is secured to the side face of the casing, and the stator shaft flange is positioned in the axial direction by being sandwiched between the recess portion and the lid member, it is possible to prevent the securing member from becoming loose and it is also possible to prevent not only rattling of the stator shaft flange the radial direction but also rattling in the axial direction.

Moreover, in accordance with the third aspect of the present invention, since the drive sprocket relatively rotatably supported on the outer periphery of the stator shaft and driven by the driving force of the drive source and the driven sprocket provided on the pump shaft of the oil pump are connected by means of the endless chain, it is possible to provide the oil pump at a position that is separated from the stator shaft and the stator shaft flange. As a result, it is possible to prevent the oil pressure generated by the oil pump from acting on a face via which the stator shaft or the stator shaft flange is joined to the casing, thus preventing the occurrence of rattling due to the oil pressure without especially strongly securing the stator shaft flange.

Furthermore, in accordance with the fourth aspect of the present invention, since the transmission includes the belt type continuously variable transmission mechanism having the endless belt wound around the first pulley and the second pulley, the first speed reduction path that can reduce in speed the rotation of the input shaft and transmit it to the first pulley, and the second speed reduction path that can reduce in speed the rotation of the second pulley and transmit it to the output shaft, the rotation of the input shaft is reduced in speed in three stages by means of the first speed reduction path, the belt type continuously variable transmission mechanism, and the second speed reduction path and is transmitted to the output shaft. As a result, a large torque acts on the gear, which is the output gear of the second speed reduction path, and a large load in the radial direction is applied to the input shaft, but because of the effect of the first aspect described above it is possible to prevent effectively the occurrence of rattling of the stator shaft flange in the radial direction.

### BRIEF DESCRIPTION OF DRAWINGS

FIG. 1 is a skeleton diagram of a continuously variable transmission. (first embodiment)

FIG. 2 is a sectional view in a direction at right angles to an axis of the continuously variable transmission. (first embodiment)

FIG. 3 is an enlarged view of part 3 in FIG. 1. (first embodiment)

FIG. 4 is a view from arrowed line 4-4 in FIG. 3. (first embodiment)

### EXPLANATION OF REFERENCE NUMERALS AND SYMBOLS

E Engine (drive source)
V Belt type continuously variable transmission mechanism
11 Transmission case (casing)
11b Side face
11c Recess portion
12 Input shaft
13A First output shaft (output shaft)
17 Torque converter
20 First pulley
21 Second pulley
22 Endless belt
30 Drive sprocket
31 Oil pump
32 Pump shaft
33 Driven sprocket
34 Endless chain
35 Stator
36 First reduction gear (first speed reduction path)
37 Second reduction gear (first speed reduction path)
38 First induction gear (gear, second speed reduction path)
39 Second induction gear (second speed reduction path)
43 Needle bearing (first bearing)
44 Stator shaft
49 Stator shaft flange
50 Lid member
59 Ball bearing (second bearing)

### MODE FOR CARRYING OUT THE INVENTION

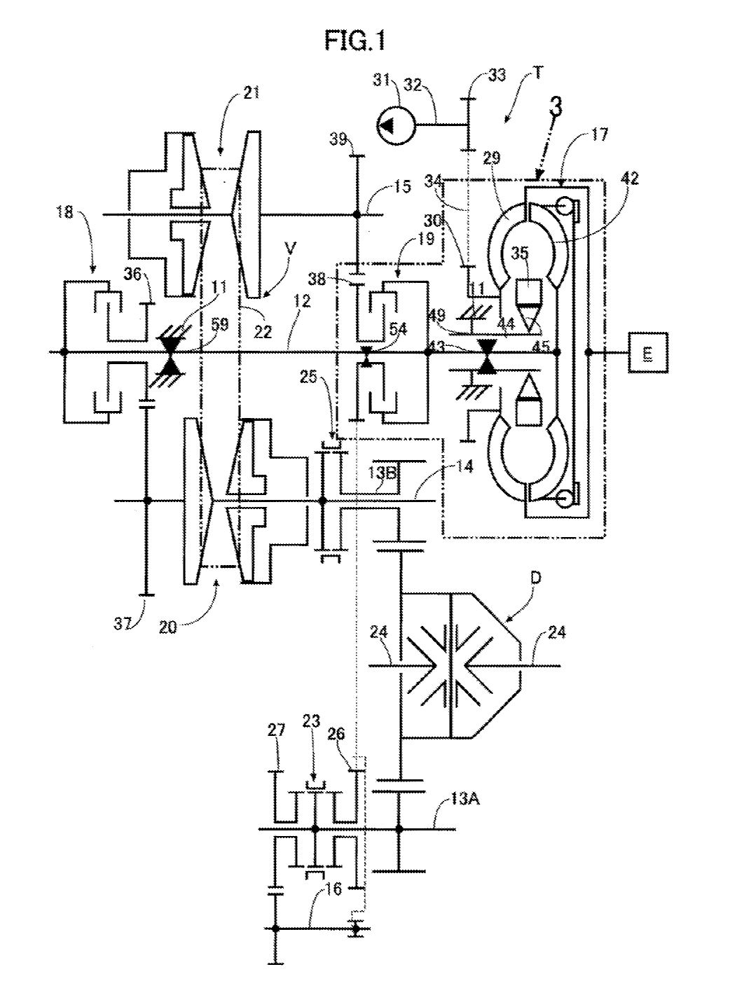

An embodiment of the present invention is explained below by reference to FIG. 1 to FIG. 4.

### First Embodiment

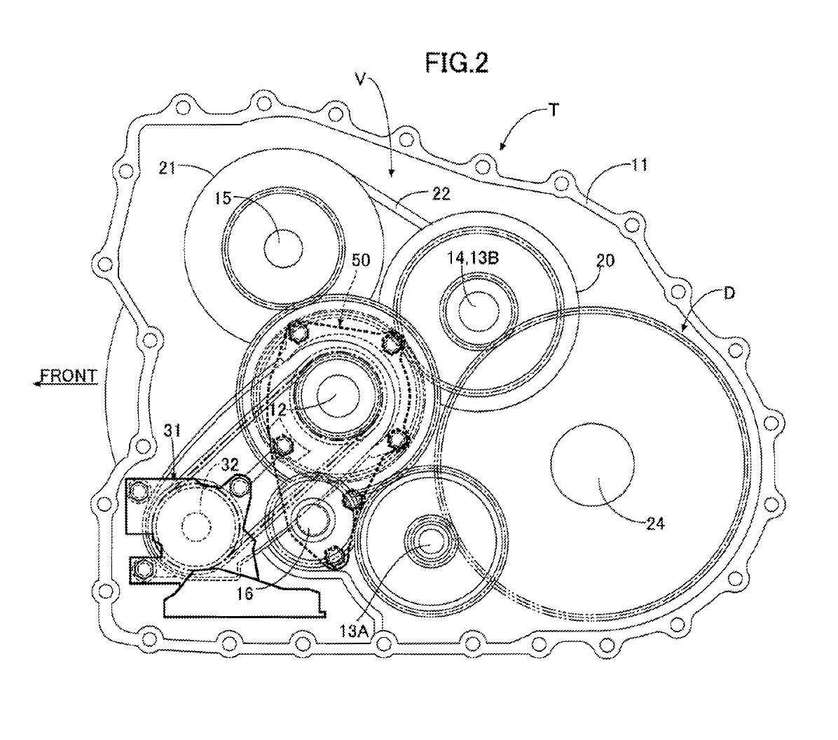

As shown in FIG. 1 and FIG. 2, a continuously variable transmission T for an automobile includes, disposed in parallel to each other in the interior of a transmission case 11, an input shaft 12, a first output shaft 13A, a first countershaft 14, a second countershaft 15, and an idle shaft 16, a second output shaft 13B being relatively rotatably fitted around the outer periphery of the first countershaft 14. The input shaft 12, to which the driving force of an engine E is transmitted via a torque converter 17 includes at opposite ends a first clutch 18 and a second clutch 19; when the first clutch 18 is engaged, the driving force of the input shaft 12 is transmitted to the first counter shaft 14, and when the second clutch 19 is engaged, the driving force of the input shaft 12 is transmitted to the second countershaft 15, a first gear 26, and the idle shaft 16.

A first pulley 20 provided on the first countershaft 14 and a second pulley 21 provided on the second countershaft 15 are connected via an endless belt 22, and the gear ratio between the first countershaft 14 and the second countershaft 15 can be varied by varying the groove width of the first and second pulleys 20 and 21. The first pulley 20, the second pulley 21, and the endless belt 22 form a belt type continuously variable transmission mechanism V.

A first synchro mechanism 23 is provided on the first output shaft 13A; when the first synchro mechanism 23 is moved rightward, the first gear 26 is joined to the first output shaft 13A, and when the first synchro mechanism 23 is moved leftward, a second gear 27 is joined to the first output shaft 13A. Furthermore, a second synchro mechanism 25 is provided between the first countershaft 14 and the second output shaft 13B; when the second synchro mechanism 25 is moved rightward, the driving force of the first countershaft 14 is transmitted to an axle 24 via the second output shaft 13B and a differential gear a

A drive sprocket 30 fixed to a pump impeller 29 of the torque converter 17 and a driven sprocket 33 fixed to a pump shaft 32 of an oil pump 31 are connected via an endless chain 34, the oil pump 31 always being driven by the driving force of the engine E.

With respect to the input shaft 12 the second countershaft 15 is disposed above and to the front, the first countershaft 14 and the second output shaft 13B are disposed above and to the rear, the pump shaft 32 is disposed beneath and to the front, the idle shaft 16 is disposed beneath, and the first output shaft 13A is disposed beneath and to the rear, the differential gear D being disposed to the rear of the shafts 12, 13A, 13B, 14, 15. 16, and 32.

In a LOW mode in which the first clutch 18 is engaged, the second clutch 19 is disengaged, the first synchro mechanism 23 is moved rightward, and the second synchro mechanism 25 is moved leftward, the driving force of the engine E is transmitted to the axle 24 via the path: torque converter 17→input shaft 12→first clutch 18→first reduction gear 36→second reduction gear 37→first countershaft 14→first pulley 20→endless belt 22→second pulley 21→second countershaft 15→second induction gear 39→first induction gear 38→first gear 26→first synchro mechanism 23→first output shaft 13A→differential gear D. Changing the groove widths of the first pulley 20 and the second pulley 21 in this LOW mode enables the gear ratio of the continuously variable transmission T to be Changed continuously on the LOW side.

In this arrangement, the first reduction gear 36 and the second reduction gear 37 form a first speed reduction path, and the second induction gear 39 and the first induction gear 38 form a second speed reduction path.

In a HI mode in which the first clutch 18 is disengaged, the second clutch 19 is engaged, the first synchro mechanism 23 is put in neutral, and the second synchro mechanism 25 is moved rightward, the driving force of the engine E is transmitted to the axle 24 via the path: torque converter 17→input shaft 12→second clutch 19→first induction gear 38→second induction gear 39→second countershaft 15→second pulley 21→endless belt 22→first pulley 20→first countershaft 14→second synchro mechanism 25→second output shaft 13B→differential gear D. Changing the groove widths of the first pulley 20 and the second pulley 21 in this HI mode enables the gear ratio of the continuously variable transmission T to be changed continuously on the HI side.

In this arrangement, the first induction gear 38 and the second induction gear 39 form a speed increasing path.

In as RVS mode in which the first clutch 18 is engaged, the second clutch 19 is disengaged, the first synchro mechanism 23 is moved leftward, and the second synchro mechanism 25 is moved leftward, the driving force of the engine E is reversed in rotation and transmitted to the axle 24 via the path: torque converter 17→input shaft 12→first clutch 18→first reduction gear 36→second reduction gear 37→first countershaft 14→first pulley 20→endless belt 22→second pulley 21→second countershaft 15→second induction gear 39→first induction gear 38→idle shaft 16→second gear 27→first synchro mechanism 23→first output shaft 13A→differential gear D. and the vehicle travels in reverse. Changing the groove widths of the first pulley 20 and the second pulley 21 in this RVS mode enables the gear ratio of the continuously variable transmission T to be changed continuously on the MIS side.

As described above, reversing the direction of power transmission between the first pulley 20 and the second pulley 21 between the LOW mode and the HI mode not only enables the total gear ratio of the continuously variable transmission T to increase up to the square of the range but also enables the vehicle to travel in reverse in the RVS mode.

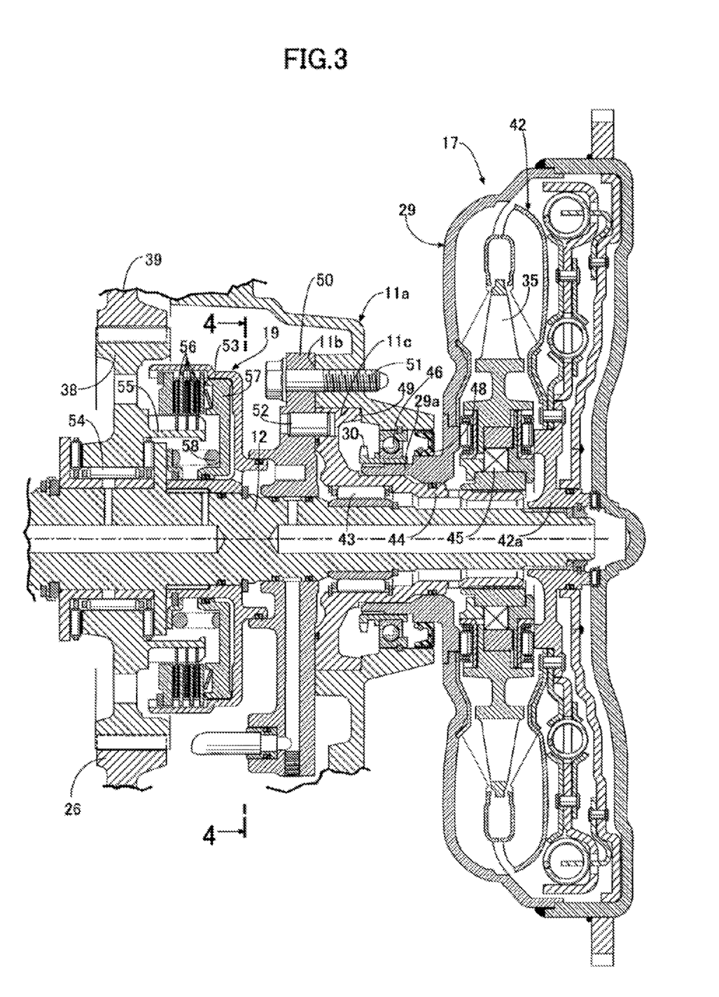

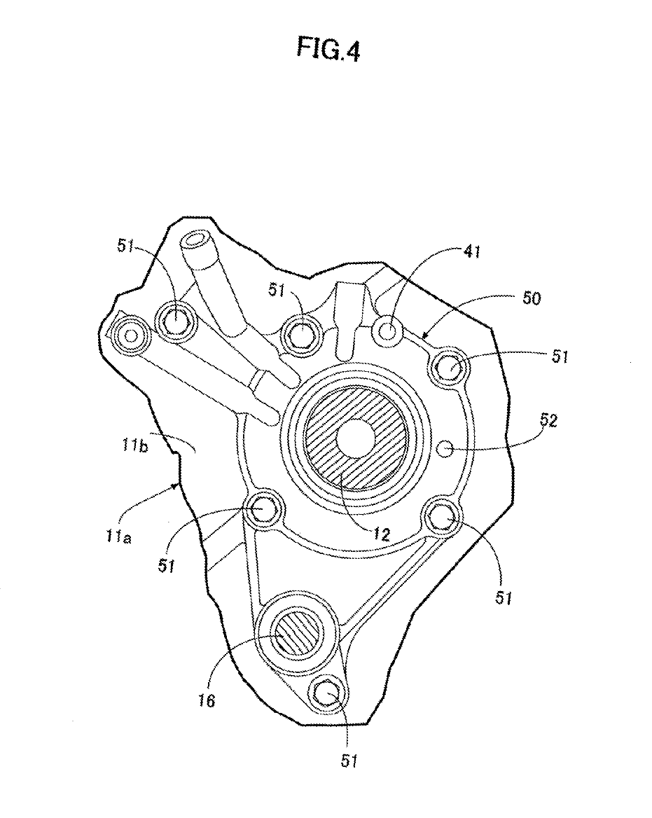

A structure for securing a stator shaft 44 of the torque converter 17 is now explained by reference to FIG. 3 and FIG. 4.

The torque converter 17 includes the pump impeller 29 connected to a crankshaft of the engine E via a drive plate, which is not illustrated, a turbine runner 42 that has a boss portion 42a fixed to a shaft end of the input shaft 12 and opposes the pump impeller 29 in the axial direction, and a stator 35 disposed on the radially inner side of the pump impeller 29 and the turbine runner 42, the inner periphery of the stator 35 being supported via a one-way clutch 45 at one end in the axial direction of the stator shaft 44, which is coaxially fitted around the outer periphery of the input shaft 12 via a needle bearing 43.

A tubular boss portion 29a of the pump impeller 29 is relatively rotatably fitted around the outer periphery of the stator shaft 44, and the drive sprocket 30 driving the oil pump 31 is fixed to the outer periphery of the boss portion 29a The drive sprocket 30 is relatively rotatably supported via a ball bearing 46 on an inner peripheral face of a torque converter case 11a housing the torque converter 17, and a seal member 48 is disposed between the boss portion 29a of the pump impeller 29 and the torque converter case 11a

A circular recess portion 11c is formed in a side face 11b of the torque converter case 11a, and a plate-shaped stator shaft flange 49 extending radially outwardly from the other end in the axial direction of the stator shaft 44 is fitted into the recess portion 11c of the torque converter case 11a The inner peripheral face of the recess portion 11c and the outer peripheral face of the stator shaft flange 49 fit without a gap in the radial direction, and the stator shaft flange 49 is positioned in the radial direction by means of the recess portion 11c.

A plate-shaped lid member 50 fitted around the outer periphery of the input shaft 12 abuts against the side face lib of the torque converter case 11a and is secured to the torque converter case 11 a by means of for example six bolts 51. As a result, the stator shaft flange 49 is sandwiched between the bottom of the recess portion 11c and the lid member 50 and is positioned in the axial direction. In this arrangement, due to a knock pin 52 being fitted into the lid member 50 and the stator shaft flange 49, the stator shaft flange 49 is positioned in the rotational direction around the axis with respect to the lid member 50. Reference numeral 41 in FIG. 4 is a knock pin for positioning the lid member 50 with respect to the torque converter case 11a Furthermore, the idle shaft 16 is supported on the lid member 50.

The first clutch 18 is disposed on the outer periphery of the input shaft 12 so as to be adjacent to the other end side in the axial direction of the lid member 50. The first clutch 18 includes a clutch drum 53 fixedly provided on the input shaft 12, a clutch hub 55 extending on one end side in the axial direction from the first induction gear 38 relatively rotatably supported on the input shaft. 12 via a needle bearing 54 a plurality of friction plates 56 disposed between the clutch drum 53 and the clutch hub 55, a clutch piston 57 urging the plurality of friction plates 56 in the direction in which they engage with each other, and a clutch spring 58 urging the clutch piston 57 in the direction in which it moves away from the plurality of friction plates 56.

The input shaft 12 is supported on the transmission case 11 via a ball bearing 59 on the side opposite to the needle bearing 43 with the first induction gear 38 sandwiched therebetween (See FIG. 1). That is, the input shaft 12 is supported on the stator shaft 44 by means of the needle bearing 43 on one end side in the axial direction with respect to the first induction gear 38 and is also supported on the transmission case 11 by means of the ball bearing 59 on the other end side in the axial direction with respect to the first induction gear 38. The needle bearing 43 forms the first bearing of the present invention, and the ball bearing 59 forms the second bearing of the present invention.

The operation of the embodiment of the present invention having the above arrangement is now explained.

When the torque of the engine E is transmitted via the first induction gear 38, the first induction gear 38 is urged in the radial direction by means of a meshing reaction force from the second induction gear 39 and the first gear 26. Part of the meshing reaction force is transmitted from the input shaft 12 to the stator shaft 44 via the needle bearing 43, is further transmitted from the stator shaft 44 to the torque converter case 11 a via the stator shaft flange 49, and is thus supported.

In this arrangement, since the outer peripheral face of the stator shaft flange 49 is fitted into the inner peripheral face of the recess portion 11c formed in the side face 11b of the torque converter case 11a, the load urging the stator shaft flange 49 in the radial direction is not transmitted to the bolts 51 via the lid member 50 but is supported directly by the recess portion 11c of the side face 11b of the torque converter case 11a As a result, since the bolts 51 may need to support a small axial load acting on the stator shaft flange 49, it is possible to prevent loosening without increasing the number of the bolts 51 or increasing the diameter of the bolts 51 thus enabling the stator shaft flange 49 to be positioned in the radial direction and in the axial direction and the occurrence of rattling to be suppressed.

In particular, in accordance with the present embodiment, while traveling in the LOW mode or the RVS mode, the rotation of the input shaft 12 is reduced in speed via the first speed reduction path that includes the first redaction gear 36 and the second reduction oar 37, is reduced in speed between the first pulley 20 and the second pulley 21 of the belt type continuously variable transmission mechanism V, and is reduced in speed via the second speed reduction path that includes the second induction gear 39 and the first induction gear 38; a very large torque is thereby input into the first induction gear 38; which is the final stage of the second speed reduction path, and the meshing reaction force acting on the first induction gear 38 becomes large, thus making it easy for the bolts 51 to become loose.

However, in accordance with the present embodiment, it is possible, by securing the stator shaft flange 49 to the torque converter case 11a with the above structure, to reliably prevent the bolts 51 from becoming loose.

In a conventional continuously variable transmission T, an oil pump is disposed so as to surround the outer periphery of a stator shaft 44, and a high pressure oil passage is sometimes formed in mating faces of the stator shaft 44 or a stator shaft flange 49 and a torque converter case 11a. If such a structure is employed, since it is necessary to increase the axial force of a bolt securing the stator shaft flange 49 to the torque converter case 11a so that it can withstand the oil pressure of the high pressure oil passage, even if the stator shaft flange 49 is secured with the structure of the present embodiment, it is difficult to decrease the number of bolts or reduce the diameter of the bolts.

However, in accordance with the present embodiment, since the oil pump 31 is disposed at a position that is separated from the stator shaft 44 and the stator shaft flange 49 and is driven by the endless chain 34, the load due to the oil pressure generated by the oil pump 31 will not act on the bolts 51 fixing the lid member 50, thus further reliably preventing the bolts 51 from becoming loose.

An embodiment of the present invention is explained above, but the present invention may be modified in a variety of ways as long as the modifications do not depart from the spirit and scope thereof.

For example, the transmission of the present invention is not limited to the continuously variable transmission T of the embodiment and may be a stepped transmission.

The drive source of the present invention is not limited to the engine E of the embodiment and may be another type of drive source such as a motor/generator.

Furthermore, the first bearing of the present invention is not limited to the needle bearing 43 of the embodiment, and the second bearing of the present invention is not limited to the ball bearing 59 of the embodiment.

1-4. (canceled)

5. A structure for securing a transmission stator shaft, in which a torque converter for transmitting a driving force of a drive source to an input shaft comprises the stator shaft that is fitted around an outer periphery of the input shaft and has a stator connected to one end thereof, and a stator shaft flange that is provided at the other end of the stator shaft and is secured to a casing, a gear for transmitting the driving force of the drive source to an output shaft being supported on the input shaft,
wherein the input shaft is supported on the stator shaft by a first bearing on one end side in an axial direction with respect to the gear and is also supported on the easing by a second bearing on the other end side in the axial direction with respect to the gear, the stator shaft flange is fitted into a recess portion formed in a side face of the casing and positioned in a radial direction, and a lid member abuts against the side face of the casing to thus secure the casing and the lid member to each other, and the stator shaft flange is sandwiched between the recess portion and the lid member and is positioned in the axial direction.

6. The structure for securing a transmission stator shaft according to claim 5, wherein a drive sprocket relatively rotatably supported on an outer periphery of the stator shaft and driven by the driving force of the drive source and a driven sprocket provided on a pump shaft of an oil pump are connected by an endless chain.

7. The structure for securing a transmission stator shaft according to claim 5, wherein the transmission comprises a belt type continuously variable transmission mechanism having an endless belt wound around a first pulley and a second pulley, a first speed reduction path that can reduce rotation of the input shaft in speed and transmit the rotation to the first pulley, and a second speed reduction path that can reduce rotation of the second pulley in speed and transmit the rotation to the output shaft, the gear being an output gear of the second speed reduction path.

8. The structure for securing a transmission stator shaft according to claim 6, wherein the transmission comprises a belt type continuously variable transmission mechanism having an endless belt wound around a first pulley and a second pulley, a first speed reduction path that can reduce rotation of the input shaft in speed and transmit the rotation to the first pulley, and a second speed reduction path that can reduce rotation of the second pulley in speed and transmit the rotation to the output shaft, the gear being an output gear of the second speed reduction path.
